(19) United States
(12) Patent Application Publication
(10) Pub. No.: US 2026/0320483 A1
(43) Pub. Date: Oct. 15, 2026

(54) METHOD AND DEVICE FOR TRAINING A MACHINE LEARNING SYSTEM

(71) Applicant: Robert Bosch GmbH, Stuttgart (DE)

(72) Inventors: Katharina Ensinger, Asperg (DE); Christoph Zimmer, Stuttgart (DE); Leon Glass, Renningen (DE)

(21) Appl. No.: 19/407,147

(22) Filed: Dec. 3, 2025

(30) Foreign Application Priority Data
Dec. 11, 2024 (DE) 10 2024 211 813.3

(51) Int. Cl. G06N 20/00; G06F 17/17

(52) U.S. Cl. CPC G06N 20/00; G06F 17/17

(57) ABSTRACT

A computer-implemented method for the active learning of a hybrid model of a technical system. The hybrid model includes a physical model component and a trainable model component which is a Gaussian process. The method includes: ascertaining a sequences of possible control signals for the technical system; for each sequence: ascertaining trajectories of states of the technical system using the hybrid model given the sequence of control signals, ascertaining a first probability with which the states of the ascertained trajectories comply with a safety requirement, removing the sequence from the sequences of possible control signals when the probability is less than or equal to a threshold value; selecting a sequence of control signals from the plurality of sequences of possible control signals which has the highest value with respect to an acquisition function among the sequences of control signals of the plurality of sequences of control signals.

### BACKGROUND INFORMATION

Germany Patent Application No. DE 10 2024 204 291.9 describes a computer-implemented method for machine learning, wherein a data set is provided, in which a measurement of an operating variable of a technical system, in particular a noisy measurement of the operating variable, is assigned in each case to a control variable of the technical system, wherein parameters of a hybrid model, in particular a hybrid differential equation, are learned according to the data set, wherein the hybrid model comprises a physical model and a data-based model, wherein the physical model is designed to determine a first part of a temporal change in the control variable of the technical system, wherein the data-based model is designed to determine a second part of the temporal change in the control variable of the technical system, wherein a control variable of the technical system is determined according to a measure, which is dependent on the control variable, for an information gain in a measurement of the operating variable of the technical system if the technical system is operated with the control variable, and according to a probability that the operation of the technical system with the control variable is safe, wherein a measurement of the operating variable assigned to the control variable, in particular a noisy measurement of the operating variable, is recorded during operation of the technical system with the control variable, wherein the control variable and the measurement assigned to the control variable are added to the data set, and wherein parameters of the hybrid model are learned with the data set to which the control variable and the measurement assigned to the control variable are added.

### SUMMARY

The development of accurate models of complex dynamic technical systems, such as those found in robotics, process control and other technical fields, often requires extensive experimental data. Active learning can be used in these cases. However, in many real-world applications, safety restrictions must be observed during the learning process to prevent the research of potentially dangerous or harmful operating areas. This challenge can be addressed through safe active learning methods.

A well-known solution for safe active learning, described in Germany Patent Application No. DE 10 2024 204 291.9, uses Gaussian processes (GPs) to model the system dynamics and a detection function based on the expected information gain to select subsequent experiments. Safety is ensured by limiting the exploration area based on predicted GP uncertainties. Specifically, Germany Patent Application No. DE 10 2024 204 291.9 uses the log-determinant of the covariance matrix as a measure of information.

Using the log determinant of the covariance matrix as a measure of information implies the assumption of a multivariate normal distribution, an assumption that generally does not apply to technical systems with nonlinear dynamics.

The present disclosure provides a novel method for safe active learning by hybrid models. The present disclosure provides a new approach to calculating an acquisition function. The acquisition function is based on mutual information between measurements and the Gaussian process, which represents the system dynamics, and more accurately reflects the information gain of a data point to be targeted in the sense of active learning. The safety function is probabilistic and ensures that selected measurements meet predefined safety limits with a high likelihood, which enables more efficient exploration within safe boundaries. Advantageously, the method of the present disclosure is not based on the assumption of a multivariate normal distribution.

The inventors were able to determine that this new method delivers better results in experiments than the related art. In particular, the improved acquisition function leads to a shorter learning time since more informative data points are selected than by methods from the related art.

In a first aspect, the present disclosure relates to a computer-implemented method for the active learning of a hybrid model of a technical system, wherein the hybrid model comprises a physical model component and a trainable model component, wherein the trainable model component is a Gaussian process. According to an example embodiment, the method comprises the following steps:
ascertaining a plurality of sequences of possible control signals for the technical system;
for each of the ascertained sequences of possible control signals:
   ascertaining a plurality of trajectories of states of the technical system by means of the hybrid model given the possible sequence of control signals;
   ascertaining a first probability with which the states of the ascertained trajectories comply with a safety requirement or a plurality of safety requirements;
   removing the sequence of possible control signals from the plurality of sequences of possible control signals if the probability is less than or equal to a specifiable threshold value;
selecting a sequence of control signals from the plurality of sequences of possible control signals, wherein the sequence of possible control signals is selected which has the highest value with respect to an acquisition function among the sequences of control signals of the plurality of sequences of control signals, wherein the acquisition function is proportional to mutual information between states resulting from the sequence of possible control signals and states predicted by the Gaussian process;
controlling the technical system with the selected sequence of control signals;
measuring a resulting trajectory of states of the technical system;
training the trainable model component by means of the selected sequence of control signals and the measured resulting trajectory of states of the technical system.

The example method can be understood in particular as the trainable model component of the hybrid model undergoing active learning through the method in the sense of machine learning, while the physical model component remains constant throughout the learning process. However, it is also possible to adjust the physical model component. By selectively choosing control signals and measuring the resulting state trajectories, new data are obtained that are used to train the trainable model component. This makes the hybrid model increasingly accurate and reliable over time.

The term “hybrid model” can be understood in particular as a mathematical model that describes the dynamics of the technical system. A hybrid model includes two different types of components: a physical model component and a trainable model component. This combination allows the use of both existing knowledge about the system and information learned from data.

The physical model component can, in particular, characterize a physical modeling of the technical system, for example based on physical laws or established engineering models. The physical model component can be understood as a priori knowledge about the system behavior and can be expressed, for example, by differential equations, algebraic equations, or other mathematical relationships.

Preferably, according to an example embodiment, the hybrid model can characterize a dynamic behavior of the technical system using the formula

$$\frac{d x}{d t} = f ( x ) + ℊ ( x ) ,$$

where f(x) is the physical model component, g(x) is the trainable system component and x characterizes the state of the technical system. The hybrid model can therefore, in particular, predict a change in the current state of the technical system. The hybrid model can therefore be used in the open-loop and closed-loop control of the technical system, in particular as a model of the technical system in model predictive control (MPC).

The term “state” can be understood as referring to a state of a technical system in the sense of an open-loop or closed-loop control of a dynamic system. A state can be represented in particular by a state vector. This vector can contain the values of relevant state variables of the system, for example, values that are relevant with regard to open-loop or closed-loop control of the system. The state variables can vary depending on the type of technical system, for example, position, velocity, acceleration, temperature, pressure, voltage, current and/or other physical quantities of the technical system.

The term “state” can also be understood to mean that it changes over time. The temporal evolution of the state can be determined in particular by the system dynamics of the technical system, which is represented by the hybrid model.

The term “state” can ultimately be understood as forming the basis for the safety assessment. By checking whether the state of the system meets the defined safety requirements, the safety of the system can be ensured. The safety requirements can be formulated in particular as polytopic constraints, i.e., as polytopes in the mathematical space of states, wherein the polytopes define a permissible range for the state.

The term “active learning” can be understood as the system independently “developing” new data points, which it uses to train the trainable component.

The expression “mutual information between states resulting from the sequence of possible control signals and states predicted by the Gaussian process” can be understood in particular as follows: initially, a first probability distribution regarding the future states is ascertained based on the possible control signals; a second probability distribution of the future states is ascertained by means of the Gaussian process; and subsequently, a difference between an entropy of the first probability distribution and an entropy of the second probability distribution is provided as mutual information. Mathematically, this can be expressed by the formula

I(y_{1:N}(ϑ),g)=H(y_{1:N}(ϑ))−H(y_{1:N}(ϑ)|g)

where I is the mutual information, H is the entropy function, y_{1:N}(ϑ) is a random variable of the sequence of future states for N time steps and dependent on a control strategy (e.g. initial value or a parameterized control strategy) and g is the Gaussian process.

The term H(y_{1:N}(ϑ)|g) is determined by g down to measurement noise. Therefore, the entropy here is proportional to the variance of the measurement noise, however in particular independent of the control strategy ϑ. Therefore, this term does not play a role in information optimization via ϑ. Preferably, the acquisition function can therefore determine the sequence of states to be targeted based solely on the first term H(y_{1:N}(ϑ)) since the first term is proportional to the maximum mutual information with the optimization of ϑ.

In particular, the entropy of the first term can be approximated. The approximation can be achieved, for example, by the formula

$$I ( {y}_{1 : N} ) ∝ H ( {y}_{1 : N} ) \approx - \frac{1}{K} {\sum }_{m = 1}^{K} log ( \frac{1}{K} {\sum }_{l = 1}^{K} 𝒩 ( {y}_{1 : N}^{m} \vert {x}_{1 : N}^{l} , {σ}^{2} ) )$$

where y_{1:N} characterizes the states resulting from the sequence of possible control signals (i.e. is y_{1:N}(ϑ), ϑ was removed for readability),

$${x}_{1 : N}^{l}$$

characterizes a sequence of states without noise, and

$${y}_{1 : N}^{m}$$

characterizes a series of noisy states.

The right side of the formula can be used in particular as a value based on which the sequence of states which has the greatest mutual information is ascertained. To ascertain the necessary sequences of states in the process based on the possible control signals, decoupled sampling can be used in particular: first, K times N outputs are sampled by means of the Gaussian process, which through integration can each be processed into sequences of states x_{1:N}. For each state x ascertained in this way, a random noise can then be drawn and the noise “added” to the state. The result is a sequence y_{1:N} of noisy states. The noise modeling can be chosen in this context by the user and can be understood as a hyperparameter of the method.

The term “safety requirement” can be understood as defining constraints on the state of the system. For example, safety requirements could specify upper limits for the temperature or pressure in a chemical reactor, minimum distances to obstacles for an autonomous vehicle, or maximum acceleration values for a robot arm.

The term “safety requirement” can be understood in particular as referring to polytopic constraints, in particular of the form Ax≤b. In this context, x is the state vector of the system, A is a matrix that linearly combines the state variables, and b is a vector that defines the upper limits for these linear combinations, i.e., the constraint. This formulation makes it possible to define complex safety limits that do not simply represent constraints on individual state variables but also take into account their interaction.

The term “sequences of possible control signals” can be understood in particular as meaning that control signals of the technical system are available for a specifiable number of time steps. The plurality of sequences of control signals then comprise these sequences of control signals. In other words, the plurality of sequences can be understood as a list of lists of control signals.

The term “ascertaining a plurality of trajectories” can be understood to mean that it includes the simulation of the hybrid model over a certain period of time for the different control signals. Starting from an initial state and a given sequence of control signals, the change of state of the system is calculated step by step by numerically solving the equations of the hybrid model.

The term “ascertaining a plurality of trajectories” can also be understood to include the ascertainment of stochastic trajectories. In the stochastic case, the model takes into account uncertainties in the model parameters or in the system behavior and provides a probability distribution over possible trajectories. In this way, a plurality of trajectories can be drawn “randomly” based on a sequence of control signals.

The term “ascertaining a plurality of trajectories” can also be understood to include the use of numerical integration methods. Various numerical methods can be used to solve the differential equations of the hybrid model, such as the Euler's method, the Runge-Kutta method or other suitable methods.

The term “acquisition function” can be understood as being able to take into account various criteria for evaluating the information gain. Examples include reducing the uncertainty of the model, maximizing mutual information, entropy, or minimizing the expected error in predicting future trajectories.

The term “acquisition function” can also be understood to mean that it takes into account the uncertainty of the predictions of the hybrid model. Usually, the greater the uncertainty of the model for a given sequence of control signals, the higher the potential information gain from conducting the corresponding experiment.

The term “acquisition function” can also be understood as being used in combination with safety requirements. In the safe active learning process, the acquisition function is not considered in isolation, but rather the sequence of control signals is selected that maximizes the acquisition function while simultaneously meeting the safety requirements. This is done by taking into account the probability, which, as described above, is calculated from the predicted trajectories and the polytopic constraints.

The term “control signal” can be understood in particular as one or more parameters that are used to influence the technical system and change its state. The control signals can be selected by the active learning algorithm in the context of the method and applied to the system to observe its response and improve the hybrid model. The control signals can take on continuous values, discrete values, or a combination of both, and depend on the specific application and the design of the technical system. For example, in the case of a robot arm, a control signal can include the joint angles, the velocity, or the torque of the motors. In a chemical process, the control signals could be the temperature, pressure, or concentration of certain chemicals. In the context of mobile robots, such as at least partially automated vehicles, a control signal can comprise linear acceleration or velocity and/or a steering angle. In the context of safe active learning, the selection of control signals is crucial since they influence both the information acquisition and the safety of the system. The algorithm advantageously selects control signals that provide as much information as possible about the system behavior while simultaneously complying with safety requirements.

According to an example embodiment, the steps of the method can be carried out iteratively in particular in order to gradually improve the hybrid model in this way. The sequences of control signals are selected and applied iteratively, with the hybrid model being updated with the newly acquired data after each iteration.

In advantageous example embodiments, it is possible that the safety requirement is characterized by a polytope in the space of the states, wherein, with respect to the safety requirement, safe states lie within the polytope.

Advantageously, the polytope allows for an easily understandable statement regarding safe ranges of the state. For example, a velocity of the system can be used as part of the state, and the polytope can numerically specify a minimum and maximum velocity. The polytope clearly indicates where the limits of the relevant state value may lie.

In advantageous example embodiments, it is also possible that ascertaining the first probability comprises the following steps:
1. for a plurality of trajectories, preferably all trajectories, ascertaining one residual value per trajectory, wherein the residual value characterizes a minimum distance of the states of the trajectory from the limit of the polytope;
2. ascertaining a probability distribution of the relevant residual values;
3. providing a second probability as a first probability, wherein the second probability characterizes a probability with which a residual value of a trajectory is negative or zero, given the probability distribution.

In the context of present disclosure, the term “residual value” can be understood to mean that it quantifies the distance of a state or state trajectory from the limit of the safe operating range defined by the polytopic constraints. It is possible to calculate a residual value for each polytopic constraint and each state along a trajectory.

The term “residual value” can also be understood as being calculated using the equation r=Ax−b. Here, x is the state vector, A is the matrix of polytopic constraints and b is the vector of upper bounds. It is possible that each entry of the residual vector r represents the distance to a specific polytopic constraint.

The term “residual value” can also be understood to mean that it is negative if the corresponding state lies within the safe operating range. It is possible that a positive residual value indicates a violation of the corresponding safety constraint. The magnitude of the residual value can be a measure of the severity of the violation.

For each trajectory, a “worst” residual value can be ascertained. The worst residual value can, for example, be the largest value r with respect to all states of the trajectory. Thus, a measure for the most uncertain state of the trajectory can be used as a measure for the entire trajectory.

Regarding the plurality of trajectories, the ascertained residual values can be understood as realizations of a random variable, thus the residual value with respect to a trajectory as “drawing from a random variable.” A probability distribution can be ascertained for this random variable, in particular in the form of a probability density function; in other words, the probability distribution can be a probability density function. Preferably, a normal distribution of the residual values can be assumed and a normal distribution can be selected as the probability density function. From the residual values of the trajectories, an expected value and a standard deviation or a variance can then be estimated by means of a maximum likelihood estimation.

For the ascertained probability distribution, it is then possible to ascertain how likely it is that a residual value is positive, i.e., that at least one safety requirement is violated. For this purpose, a distribution function of the probability density function can be used in particular to ascertain the proportion of the probability density function that is negative.

In preferred example embodiments, estimating the standard deviation or variance may include the following steps:
estimating an intermediate standard deviation or an intermediate variance by means of a maximum likelihood estimation;
multiplying the intermediate standard deviation or the intermediate variance by a specifiable safety value;
providing the product of the intermediate standard deviation and the safety value as the standard deviation, or providing the product of the intermediate variance and the safety value as the variance.

Advantageously, this allows the probability distribution of the residual values to be adjusted in order to incorporate a “safety buffer” or to obtain a probability of safety that can be quantified in percent. A value of 2 corresponds to a probability of approximately 2.5% in the uncertain range. A value of 3 corresponds to a probability of approximately 0.2%. The safety value is therefore a hyperparameter that can be set by the user according to their safety preferences.

Alternatively, in the method above, it is also possible that, instead of a plurality of trajectories, only one trajectory is ascertained based on the sequence of possible control signals, and wherein ascertaining the probability comprises the following steps:
ascertaining a residual value with respect to the trajectory, wherein the residual value characterizes a minimum distance of the states of the trajectory from the limit of the polytope;
providing a probability of 0 if the residual value is greater than zero, and 1 otherwise.

This can be understood to mean that for each sequence of control signals, only one residual value is ascertained and only this residual value is considered. This advantageously allows the need for computing resources to be further reduced.

In advantageous example embodiments, it can also be provided that the trainable model component is pre-trained by the following steps prior to the active learning steps:
receiving data, wherein the data characterize trajectories of states of the technical system;
training the trainable model component based on the received data.

Pre-training can be understood as preceding the active learning. Advantageously, the trainable model component can thus be pre-trained and better configured for the subsequent active learning. The inventors were able to determine that this could shorten the active learning process until a sufficiently high predictive accuracy of the hybrid model is achieved. In particular, this pre-training can identify an initial safe range from which the active learning method can “start.”

In the various example embodiments of the present disclosure, it may also be provided that the technical system is a mobile robot, in particular an at least partially automated vehicle, and/or that the state characterizes a position and/or a velocity and/or an acceleration of the technical system.

Example embodiments of the present disclosure are explained in detail below with reference to the figures.

### BRIEF DESCRIPTION OF THE DRAWINGS

FIG. 1 schematically shows a method for the active learning of a hybrid model, according to an example embodiment.

FIG. 2 schematically shows a structure of a control system for controlling an actuator, according to an example embodiment.

FIG. 3 schematically shows an exemplary embodiment for controlling a mobile robot.

### DETAILED DESCRIPTION OF EXAMPLE EMBODIMENTS

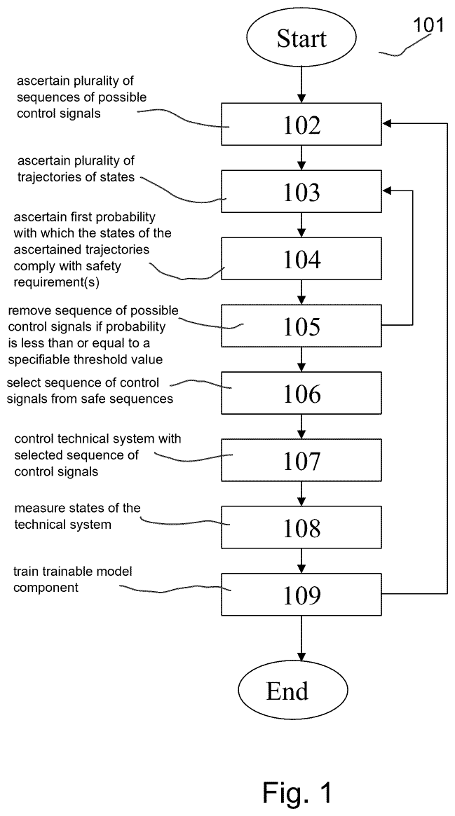

FIG. 1 schematically shows a computer-implemented method (101) for the active learning of a hybrid model of a technical system. The hybrid model comprises a physical model component and a trainable model component. The physical model component can be formulated in particular as a differential equation of the technical. The trainable model component can be given in particular in the form of a Gaussian process. The hybrid model can combine the two model components, in particular through addition, and thus characterize the dynamic behavior of the technical system using the formula

$$\frac{d x}{d t} = f ( x ) + ℊ ( x ) ,$$

where f(x) is the physical model component and g(x) is the trainable model component. In the exemplary embodiment, the trainable model component is preferably a Gaussian process. Preferably, the trainable model component can already be pre-trained, i.e., trained based on a training data set, prior to the steps of the method. The training steps can be carried out in particular as part of the active learning method.

In a first step (102) of the active learning method, a plurality of sequences of possible control signals for the technical system is ascertained. A control signal can be understood here as a parameter or quantity with which the technical system can be controlled, i.e., influenced. In particular, the control signals can be sequences of desired positions or actions of an actuator, e.g., a command to a brake to apply a certain brake pressure or a command to a steering system to apply a certain steering angle. In particular, the possible control signals can be randomly ascertained within a limit of allowed values.

For each of these sequences of possible control signals and starting from a current state of the technical system, a plurality of trajectories of states of the technical system is then ascertained in a second step (103) by the hybrid model. In other words, the hybrid model is used to ascertain or predict which states the technical system will assume based on the current state and the sequence of control signals executed from there. This process can in particular be probabilistic; in other words, the hybrid model can characterize uncertainty about model parameters, for example in a Gaussian process by means of the covariance function. Based on the covariance function of the Gaussian process, a plurality of trajectories can then be “drawn” based on a single sequence of control signals.

In a third step (104), a first probability is ascertained with which the states of the ascertained trajectories comply with a safety requirement or a plurality of safety requirements. A safety requirement can be defined, in particular, in the form of a polytope within which a state must be located in order to be considered safe. For example, the condition may comprise a deviation of the technical system with respect to a specified trajectory of physical positions, and a safety polytope can define a maximum deviation in the positive and negative directions.

The first probability can be ascertained in particular by considering residual values. Thus, the polytope, which imposes a safety requirement on the state, can be defined by the formula

Ax≤b

(see above). A residual value

r=Ax−b

can then be understood as a numerical measure of the violation of the safety requirement: if r is negative, the safety requirement is not violated; if r is positive 0, the safety requirement is violated by the state x. The numerical value 0 can be defined in accordance with the method as positive or negative. Thus, for a trajectory of states, a residual value r can be determined at any point in time of the trajectory. In particular, a residual value can also be ascertained for different safety requirements and thus for a plurality of polytopes for each state of the trajectory.

Each trajectory can then be represented by its maximum residual value. This can be understood to mean that the residual value describes the “most dangerous” situation of the trajectory, and a trajectory is thus measured based on its smallest distance to the limit of a polytope. This value can be understood as a maximum violation of a safety requirement (if positive) or as a minimum distance for a violation of a safety requirement (negative).

For the residual values ascertained in this way for each trajectory, a probability distribution of the residual values can then be ascertained. This can be understood as meaning that the residual value over trajectories is considered a random variable, i.e., given a sequence of control signals, the actual residual value is a random variable (based on the uncertainty of the model parameters of the trainable model component). Based on the probability distribution, the probability can then be ascertained that the residual value for the sequence of control signals is positive, meaning that a safety requirement will be violated, and that the sequence of control signals is therefore unsuitable.

In particular, the residual values for each trajectory can be used to estimate an expected value and a standard deviation or variance of a normal distribution, i.e., it can be assumed that the residual values follow a normal distribution. The first probability value can then be provided as an integral of the normal distribution (given the ascertained expected value and the ascertained standard deviation or variance) from negative infinity to 0. Preferably, this can be done using a distribution function of the normal distribution.

Preferably, it is possible to multiply the standard deviation or variance by a specifiable safety value before ascertaining the integral. This creates an additional “safety buffer” by artificially increasing the variance and thus making a violation of the safety requirements more likely. The safety value can be understood as a hyperparameter of the method.

In a fourth step (105), the sequence of possible control signals is removed from the plurality of sequences of possible control signals if the probability is less than or equal to a specifiable threshold value. The probability characterizes the degree to which the corresponding sequence of control signals reliably complies with the given safety requirements. Removing sequences based on the probability can therefore be understood to mean that only sequences of control signals that can be assumed with sufficient certainty not to violate the safety requirements will actually be used in what follows.

Steps 2 to 4 are performed iteratively for all sequences of possible control signals and a plurality of safe sequences of control signals is thus ascertained.

From this plurality of safe sequences of control signals thus ascertained, a sequence of control signals is then selected in a sixth step (106), wherein the sequence of control signals that has a highest value with respect to an acquisition function among the sequences of control signals of the plurality of sequences of control signals is selected. This can be understood as first determining safe sequences of control signals and then selecting from these sequences the sequence that maximizes the acquisition function. This ensures that the sequence of control signals reliably controls the technical system and also selects a maximally informative data point for active learning purposes.

The acquisition function selects from the possible sequences of control signals the sequence of control signals that leads to a sequence of states with maximum mutual information. Mathematically, the mutual information of a sequence of states can be expressed by the formula

I(y_{1:N}(ϑ),g)=H(y_{1:N}(ϑ))−H(y_{1:N}(ϑ)|g)

where I is the mutual information, H is the entropy function, y_{1:N}(ϑ) is a random variable of the sequence of states for N time steps and dependent on a control strategy (e.g. initial value or a parameterized control strategy) and g is the Gaussian process.

The term H(y_{1:N}(ϑ)|g) is determined by g down to measurement noise. Therefore, the entropy here is proportional to the variance of the measurement noise, however in particular independent of the control strategy ϑ. Therefore, this term does not play a role in information optimization via ϑ. Preferably, the acquisition function can therefore determine the sequence of states to be targeted based solely on the first term H(y_{1:N}(ϑ)) since the first term is proportional to the maximum mutual information with the optimization of ϑ.

In particular, the entropy of the first term can be approximated. The approximation can be achieved, for example, by the formula

$$I ( {y}_{1 : N} ) ∝ H ( {y}_{1 : N} ) \approx - \frac{1}{K} {\sum }_{m = 1}^{K} log ( \frac{1}{K} {\sum }_{l = 1}^{K} 𝒩 ( {y}_{1 : N}^{m} \vert {x}_{1 : N}^{l} , {σ}^{2} ) )$$

where y_{1:N} characterizes the states resulting from the sequence of possible control signals (i.e. is y_{1:N}(ϑ), ϑ was removed for readability),

$${x}_{1 : N}^{l}$$

characterizes a sequence of states without noise, and

$${y}_{1 : N}^{m}$$

Characterizes a series of noisy states.

The right side of the formula can be used in particular as a value based on which the sequence of states which has the greatest mutual information is ascertained. To ascertain the necessary sequences of states in the process based on the possible control signals, decoupled sampling can be used in particular: first, K times N outputs are sampled by means of the Gaussian process, which through integration can each be processed into sequences of states x_{1:N}. For each state x ascertained in this way, a random noise can then be drawn and the noise “added” to the state. The result is a sequence y_{1:N}Of noisy states. The noise modeling can be chosen in this context by the user and can be understood as a hyperparameter of the method.

In a sixth step (107), the selected sequence of control signals is used to control the technical system according to the sequence of control signals, wherein, in a seventh step (108), the states of the technical system resulting from the control signals are measured.

In an eighth step (109), the trainable model component is trained by means of the selected sequence of control signals and the measured resulting trajectory of states of the technical system.

The steps of the method can be carried out iteratively in particular in order to gradually refine the hybrid model in this way.

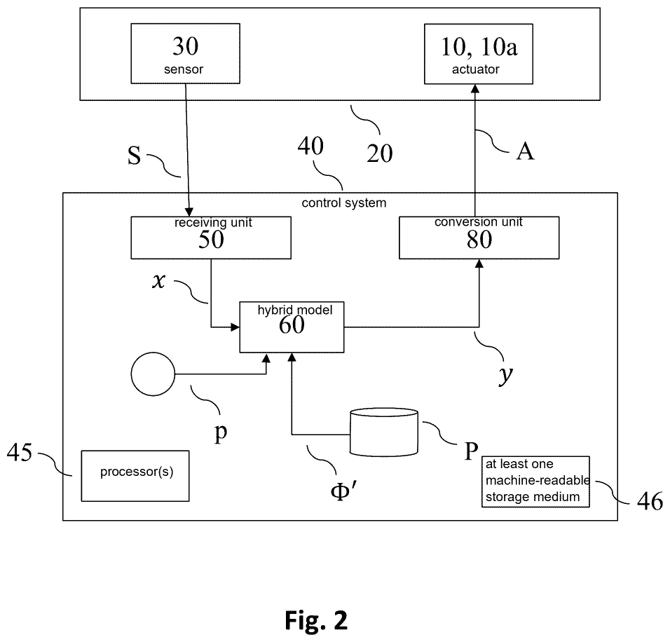

FIG. 2 shows a control system (40) which ascertains control signals (A) of an actuator (10) of a technical system by means of a hybrid model (60). At preferably regular time intervals, an environment (20) of the actuator (10) is detected using a sensor (30), in particular an imaging sensor such as a camera sensor, which can also be provided by a plurality of sensors, for example a stereo camera. The sensor signal(S)—or, in the case of a plurality of sensors, one sensor signal(S) each—of the sensor (30) is transmitted to the control system (40). The control system (40) thus receives a sequence of sensor signals(S) that characterize a state of the technical system. Therefrom, the control system (40) ascertains control signals (A) for the active learning of the hybrid model (60). The control signals (A) will be transmitted to the actuator (10).

The control system (40) receives the sequence of sensor signals(S) from the sensor (30) in an optional receiving unit (50), which converts the sequence of sensor signals(S) into a state signal (x) (alternatively, the sensor signal(S) can also be adopted directly as a state signal (x) in each case). The state signal (x) can, for example, be a portion or a further processing of the sensor signal(S). In other words, the state signal (x) is ascertained depending on the sensor signal(S). The state signal (x) represents the current state of the technical system.

The hybrid model (60) comprises a physical model component and a trainable model component (g(x)), as described in FIG. 1 and the associated exemplary embodiment. The hybrid model (60) is preferably parameterized by parameters (@) that are stored in a parameter memory (P) and are provided thereby.

From the state signal (x) and using the hybrid model (60), the control system (40) ascertains possible future state trajectories for a plurality of possible control signals (A). The outputs (y) of the hybrid model (60) are characterized by a trajectory of changes of a particular state using a sequence of possible control signals (p). The hybrid model (60) generates a plurality of these trajectories. This plurality is fed to a conversion unit (80), which ascertains trajectories of states of the technical system from said plurality. Based on these trajectories, the conversion unit then ascertains the first probability, as described in the exemplary embodiment of FIG. 1. Based thereon, as described in the exemplary embodiment, the sequence of control signals (A) is then ascertained, which are fed to the actuator (10) in order to control the actuator (10) accordingly.

The actuator (10) receives the control signals (A), is controlled accordingly and performs a corresponding action. Here, the actuator (10) can comprise a control logic (not necessarily structurally integrated), which ascertains, from the control signal (A), a second control signal with which the actuator (10) is then controlled. The resulting trajectory of actual states of the technical system is measured and fed to the hybrid model (60) for training the trainable model component (g(x)), as described in steps (108) and (109) of the first exemplary embodiment.

In further embodiments, the control system (40) comprises the sensor (30). In still further embodiments, the control system (40) alternatively or additionally also comprises the actuator (10).

In further preferred embodiments, the control system (40) comprises at least one processor (45) and at least one machine-readable storage medium (46) on which instructions are stored that, when executed on the at least one processor (45), cause the control system (40) to execute the method according to the present disclosure.

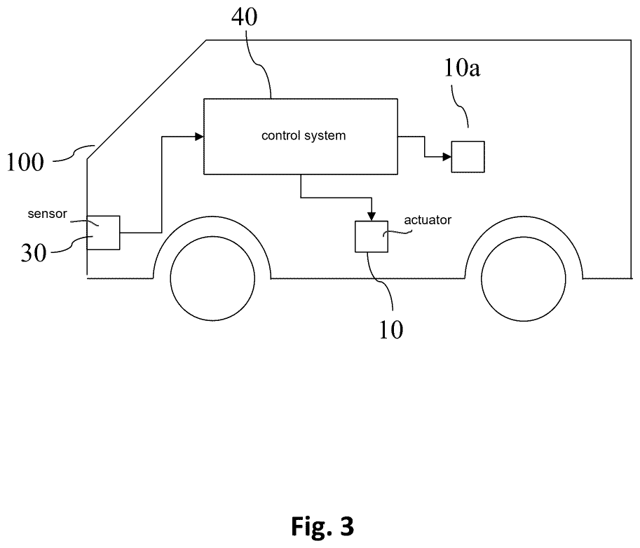

FIG. 3 shows how the control system (40) can be used to control a mobile robot, here an at least partially automated motor vehicle (100).

The sensor (30) can, for example, be acceleration sensors and/or velocity sensors, preferably arranged in the robot (100), of wheels or chains of the robot (100).

The actuator (10), which is preferably arranged in the robot (100), can, for example, be a brake, a drive and/or a steering system of the motor vehicle (100).

Alternatively, the robot can also be a mobile robot other than a vehicle, for example one that moves by flying, swimming, diving or walking. The mobile robot can, for example, be an at least partially autonomous lawnmower or an at least partially autonomous cleaning robot.

The term “computer” refers to any device for processing specifiable calculation rules. These calculation rules can be in the form of software, or in the form of hardware, or even in a mixed form of software and hardware.

In general, a plurality can be understood as indexed, i.e., each element of the plurality is assigned a unique index, preferably by assigning consecutive integers to the elements contained in the plurality. Preferably, when a plurality comprises N elements, where N is the number of elements in the plurality, the elements are assigned integers from 1 to N.

1-14. (canceled)

15. A computer-implemented method for active learning of a hybrid model of a technical system, wherein the hybrid model includes a physical model component and a trainable model component, wherein the trainable model component is a Gaussian process, and wherein the method comprises the following steps:
ascertaining a plurality of sequences of possible control signals for the technical system;
for each sequence of possible control signals of the ascertained sequences of possible control signals:
ascertaining, using the hybrid model, a plurality of trajectories of states of the technical system, given the sequence of possible control signals,
ascertaining a first probability with which the states of the ascertained trajectories comply with a safety requirement,
removing the sequence of possible control signals from the plurality of sequences of possible control signals when the first probability is less than or equal to a specifiable threshold value;
selecting a sequence of control signals from the plurality of sequences of possible control signals, wherein the sequence of control signals is selected which has a highest value with respect to an acquisition function among the sequences of possible control signals of the plurality of sequences of possible control signals, wherein the acquisition function is proportional to mutual information between states resulting from the sequence of possible control signals and states predicted by the Gaussian process;
controlling the technical system with the selected sequence of control signals;
measuring a resulting trajectory of states of the technical system;
training the trainable model component using the selected sequence of control signals and the measured resulting trajectory of states of the technical system.

16. The method according to claim 15, wherein the acquisition function characterizes an entropy of the states resulting from the sequence of possible control signals.

17. The method according to claim 16, wherein the entropy of the states resulting from the sequence of possible control signals is approximated based on the following formula:
$$H ( {y}_{1 : N} ) \approx - \frac{1}{K} {\sum }_{m = 1}^{K} log ( \frac{1}{K} {\sum }_{l = 1}^{K} 𝒩 ( {y}_{1 : N}^{m} \vert {x}_{1 : N}^{l} , {σ}^{2} ) )$$
where y_{1:N} characterizes the states resulting from the sequence of possible control signals,
$${x}_{1 : N}^{l}$$
characterizes a sequence of states without noise, and
$${y}_{1 : N}^{m}$$
characterizes a series of noisy states.

18. The method according to claim 15, wherein the safety requirement is characterized by a polytope in a space of the states, wherein safe states with respect to the safety requirement lie within the polytope.

19. The method according to claim 18, wherein the ascertaining of the first probability includes the following steps:
for a plurality of the trajectories, ascertaining one residual value per trajectory, wherein the residual value characterizes a minimum distance of the states of the trajectory from a limit of the polytope;
ascertaining a probability distribution of the residual values; and
providing a second probability as a first probability, wherein the second probability characterizes a probability with which a residual value of a trajectory is negative or zero, given the probability distribution.

20. The method according to claim 19, wherein the probability distribution is characterized by a normal distribution, and ascertaining the probability distribution includes: (i) estimating a mean value and (ii) estimating a standard deviation or variance from the normal distribution.

21. The method according to claim 20, wherein the estimation of the standard deviation or variance includes the following steps:
estimating an intermediate standard deviation or an intermediate variance using a maximum likelihood estimation;
multiplying the intermediate standard deviation or the intermediate variance by a specifiable safety value;
providing a product of the intermediate standard deviation and the safety value as the standard deviation, or providing the product of the intermediate variance and the safety value as the variance.

22. The method according to claim 19, wherein: (i) a constraint of the polytope is characterized by the following formula:
Ax≤b
where x is a state of the technical system, A characterizes a matrix and b a numerical description of the safety requirement, and/or (ii) the residual value is characterized by the following formula: r=Ax−b.

23. The method according to claim 15, wherein the trainable model component is pre-trained by the following steps:
receiving data, wherein the data characterize trajectories of states of the technical system;
training the trainable model component based on the received data.

24. The method according to claim 15, wherein: (i) the technical system is a mobile robot, and/or (ii) each state characterizes a position and/or a velocity and/or an acceleration.

25. A training device configured to execute a method for active learning of a hybrid model of a technical system, wherein the hybrid model includes a physical model component and a trainable model component, wherein the trainable model component is a Gaussian process, and wherein the method comprises the following steps:
ascertaining a plurality of sequences of possible control signals for the technical system;
for each sequence of possible control signals of the ascertained sequences of possible control signals:
ascertaining, using the hybrid model, a plurality of trajectories of states of the technical system, given the sequence of possible control signals,
ascertaining a first probability with which the states of the ascertained trajectories comply with a safety requirement,
removing the sequence of possible control signals from the plurality of sequences of possible control signals when the first probability is less than or equal to a specifiable threshold value;
selecting a sequence of control signals from the plurality of sequences of possible control signals, wherein the sequence of control signals is selected which has a highest value with respect to an acquisition function among the sequences of possible control signals of the plurality of sequences of possible control signals, wherein the acquisition function is proportional to mutual information between states resulting from the sequence of possible control signals and states predicted by the Gaussian process;
controlling the technical system with the selected sequence of control signals;
measuring a resulting trajectory of states of the technical system;
training the trainable model component using the selected sequence of control signals and the measured resulting trajectory of states of the technical system.

26. A non-transitory machine-readable storage medium on which is stored a computer program for active learning of a hybrid model of a technical system, wherein the hybrid model includes a physical model component and a trainable model component, wherein the trainable model component is a Gaussian process, and wherein the computer program, when executed by a processor, causing the processor to perform the following steps comprising:
ascertaining a plurality of sequences of possible control signals for the technical system;
for each sequence of possible control signals of the ascertained sequences of possible control signals:
ascertaining, using the hybrid model, a plurality of trajectories of states of the technical system, given the sequence of possible control signals,
ascertaining a first probability with which the states of the ascertained trajectories comply with a safety requirement,
removing the sequence of possible control signals from the plurality of sequences of possible control signals when the first probability is less than or equal to a specifiable threshold value;
selecting a sequence of control signals from the plurality of sequences of possible control signals, wherein the sequence of control signals is selected which has a highest value with respect to an acquisition function among the sequences of possible control signals of the plurality of sequences of possible control signals, wherein the acquisition function is proportional to mutual information between states resulting from the sequence of possible control signals and states predicted by the Gaussian process;
controlling the technical system with the selected sequence of control signals;
measuring a resulting trajectory of states of the technical system;
training the trainable model component using the selected sequence of control signals and the measured resulting trajectory of states of the technical system.

27. A computer-implemented method for active learning of a hybrid model of a technical system, wherein the hybrid model includes a physical model component and a trainable model component, wherein the trainable model component is a Gaussian process, and wherein the method comprises the following steps:
ascertaining a plurality of sequences of possible control signals for the technical system;
for each sequence of possible control signals of the ascertained sequences of possible control signals:
ascertaining, using the hybrid model, only one trajectory of states of the technical system, given the sequence of possible control signals,
ascertaining a first probability with which the states of the ascertained trajectory complies with a safety requirement,
removing the sequence of possible control signals from the plurality of sequences of possible control signals when the first probability is less than or equal to a specifiable threshold value;
selecting a sequence of control signals from the plurality of sequences of possible control signals, wherein the sequence of control signals is selected which has a highest value with respect to an acquisition function among the sequences of possible control signals of the plurality of sequences of possible control signals, wherein the acquisition function is proportional to mutual information between states resulting from the sequence of possible control signals and states predicted by the Gaussian process;
controlling the technical system with the selected sequence of control signals;
measuring a resulting trajectory of states of the technical system; and
training the trainable model component using the selected sequence of control signals and the measured resulting trajectory of states of the technical system;
wherein the safety requirement is characterized by a polytope in a space of the states, wherein safe states with respect to the safety requirement lie within the polytope, and
wherein ascertaining the first probability includes the following steps:
ascertaining a residual value with respect to the trajectory, wherein the residual value characterizes a minimum distance of the states of the trajectory from a limit of the polytope, and
providing the first probability of 0 when the residual value is greater than zero, and 1 otherwise.
